(19) United States
(12) Patent Application Publication
(10) Pub. No.: US 2010/0165088 A1
(43) Pub. Date: Jul. 1, 2010

(54) Apparatus and Method for Displaying Capsule Endoscope Image, and Record Media Storing Program for Carrying out that Method

(75) Inventor: Young Dae SEO, Gyeonggi-do (KR)

Correspondence Address: HARNESS, DICKEY & PIERCE, P.L.C., P.O. BOX 828, BLOOMFIELD HILLS, MI, 48303, US

(73) Assignee: IntroMedic, Seoul (KR)

(21) Appl. No.: 12/639,462

(22) Filed: Dec. 16, 2009

(30) Foreign Application Priority Data
Dec. 29, 2008 (KR) 102008-0135667
Aug. 7, 2009 (KR) 102009-0072582

(51) Int. Cl. H04N 7/18

(52) U.S. Cl. 348/65; 348/E07.085

(57) ABSTRACT

An apparatus and method for displaying capsule endoscope images and record media storing a program for carrying out that method is disclosed, which is capable of reducing playing time of the capsule endoscope images by forming a plurality of similar-image groups with a plurality of image frames from an endoscope image stream, and displaying a representative image frame for each similar-image group, the method comprising receiving image data taken by a capsule endoscope inserted into the inside of an examinee; generating an endoscope image stream by using the received image data; forming a plurality of similar-image groups with a plurality of image frames by using the endoscope image stream; determining a representative image frame for each similar-image group by using the image frames included in each similar-image group; and displaying the representative image frame for each similar-image group.

### CROSS REFERENCE TO RELATED APPLICATIONS

This application claims the benefit of the Korean Patent Application Nos. P2008-0135667 filed on Dec. 29, 2008 and P2009-0072582 filed on Aug. 7, 2009, which are hereby incorporated by reference as if fully set forth herein.

### BACKGROUND OF THE INVENTION

1. Field of the Invention

The present invention relates to a capsule endoscope, and more particularly, to an apparatus and method for displaying capsule endoscope images (wherein, the capsule endoscope images indicate images taken by a capsule endoscope).

2. Discussion of the Related Art

Recently, a capsule endoscope has been developed for observing a subject to be examined, for example, intestines of a living body without suffering pains, which can be used for medical diagnosis in the medical field. From swallowing this ingestible capsule endoscope by a mouth of the living body until being naturally discharged out of the living body, the capsule endoscope traversing the internal of the living body takes intra-subject images, that is, images of stomach, small intestine, large intestine and etc. at a predetermined time rate. The images taken by the capsule endoscope are uploaded to a workstation via a receiving device and displayed on a display device through the use of diagnosis software installed in the workstation. An observer (which will be a doctor or nurse to make the medical diagnosis) makes the medical diagnosis by using the images taken by the capsule endoscope to write a report (medical diagnosis). At this time, the diagnosis software displays the images, which are taken in the time-sequential order by the capsule endoscope, on the display device at intervals of predetermined time.

The related art capsule endoscope takes 2 or 3 serial images per second for a long period of time. Thus, the observer makes the report (medical diagnosis) after observing a large volume of the serial images taken by the capsule endoscope, whereby it is inevitable for the observer to require lots of time on diagnosis.

Since the related art capsule endoscope includes no additional transferring means, the capsule endoscope takes the intra-subject images while traversing the intestines of the living body by the peristalsis. That is, the similar images taken in the neighboring areas or close time points may cause redundancy on diagnosis, thereby wasting unnecessary time.

Due to the increase of cost induced by the long examination time, the capsule endoscope has been not widely popular.

### SUMMARY OF THE INVENTION

Accordingly, the present invention is directed to an apparatus and method for displaying capsule endoscope images and record media storing a program for carrying out that method that substantially obviates one or more problems due to limitations and disadvantages of the related art.

An aspect of the present invention is to provide an apparatus and method for displaying capsule endoscope images and record media storing a program for carrying out that method, which is capable of reducing playing time of the capsule endoscope images by forming a plurality of similar-image groups with a plurality of image frames from an endoscope image stream, and displaying a representative image frame for each similar-image group.

Another aspect of the present invention is to provide an apparatus and method for displaying capsule endoscope images and record media storing a program for carrying out that method, which is capable of reducing playing time of the capsule endoscope images without lowering preciseness in diagnosis by displaying a corresponding representative image frame together with a plurality of neighboring image frames determined in a similar-image group of the corresponding representative image frame, or by displaying a corresponding representative image frame together with image frames included in a similar-image group of the corresponding representative image frame when a specific event occurs.

Additional features and aspects of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these and other advantages and in accordance with the purpose of the invention, as embodied and broadly described herein, a method for displaying a capsule endoscope image comprises receiving image data taken by a capsule endoscope inserted into the inside of an examinee; generating an endoscope image stream by using the received image data; forming a plurality of similar-image groups with a plurality of image frames by using the endoscope image stream; determining a representative image frame for each similar-image group by using the image frames included in each similar-image group; and displaying the representative image frame for each similar-image group.

The plurality of similar-image groups are formed by using at least one of a similarity between each of the image frames for the endoscope image stream, location data of the capsule endoscope, and disease and bleeding analysis data obtained by detecting at least one of disease and bleeding patterns from the image frames for the endoscope image stream.

The step of determining the representative image frame comprises selecting any one image frame from the image frames included in each similar-image group; or combining one or more image frames among the image frames included in each similar-image group.

If selecting any one image frame from the image frames included in each similar-image group, the representative image frame is determined to be the image frame which is temporally or spatially positioned at the center of each similar-image group; the image frame having the highest dynamic range based on a histogram of grayscale; the image frame having the highest brightness; or the image frame having the highest complexity based on the number of edges of the image frame.

If combining one or more image frames among the image frames included in each similar-image group, the representative image frame is generated by an average image of the image frames included in one similar-image group; the representative image frame is generated by overlapping the image frames included in one similar-image group and being emphasized at their edges being not perfectly overlapped; or the representative image frame is generated by combining one or more image frames applied with a weight among the image frames included in one similar-image group.

The step of displaying the representative image frame comprises displaying the corresponding representative image frame together with other representative image frames which are temporally positioned adjacent to the corresponding representative image frame.

In addition, the method further comprises determining a plurality of neighboring image frames among the image frames included in each similar-image group, wherein the corresponding representative image frame is displayed together with the plurality of neighboring image frames determined in the similar-image group of the corresponding representative image frame for the step of displaying the representative image frame.

The plurality of neighboring image frames are determined by using at least one of the temporal or spatial first and last image frames among the image frames included in each similar-image group; the image frames of the next-highest ranked dynamic range based on the histogram of grayscale after the representative image frame; the image frames of the next-highest ranked brightness after the representative image frame; the image frames of the next-highest ranked complexity based on the number of edges of the image frame after the representative image frame.

The number of neighboring image frames is determined by any one of a user, playing time of the image frames included in each similar-image group, the number of the representative image frames displayed on a diagnosis screen, and the number of the image frames included in the similar-image group.

In addition, the method further comprises determining whether or not a specific event occurs, wherein, if the specific event occurs, the corresponding representative image frame is displayed together with the individual image frames included in the similar-image group of the corresponding representative image frame for the step of displaying the representative image frame.

The specific event indicates that the user selects a playing-stop button or temporarily playing-stop button, or clicks or double-clicks on the representative image frame for the step of displaying the representative image frame.

In another aspect of the present invention, an apparatus for displaying a capsule endoscope image comprises an endoscope image stream generating unit for generating an endoscope image stream by using image data taken by a capsule endoscope inserted into the inside of an examinee; a similar-image group forming unit for forming a plurality of similar-image groups with a plurality of image frames by using the endoscope image stream; a representative image frame determining unit for determining a representative image frame for each similar-image group by using at least one image frame among the image frames included in each similar-image group; and an image outputting unit for displaying the representative image frame determined by the representative image frame determining unit on a display device.

It is to be understood that both the foregoing general description and the following detailed description of the present invention are representative and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a system for displaying capsule endoscope images according to the embodiment of the present invention;

FIG. 2 is a block diagram illustrating a workstation according to one embodiment of the present invention;

FIG. 3 illustrates images taken by a capsule endoscope of FIG. 1;

FIG. 4 illustrates a similarity between each of neighboring image frames;

FIG. 5 illustrates disease/bleeding analysis data obtained by a similar-image group forming unit of FIG. 2;

FIG. 6 illustrates capsule-moving speed data obtained by a similar-image group forming unit of FIG. 2;

FIG. 7 illustrates a histogram for each grayscale obtained by a representative image frame determining unit of FIG. 2;

FIG. 8 illustrates image edges by an image complexity;

FIG. 9 illustrates a representative image frame generated by overlapping individual images and emphasizing their edges being not perfectly overlapped;

FIG. 10 illustrates a plurality of representative image frames displayed together;

FIGS. 11 to 15 illustrate an image-displaying area according to various embodiments of the present invention;

FIG. 16 illustrates a corresponding representative image frame displayed together with individual image frames included in a similar-image group of the corresponding representative image frame;

FIG. 17 is a flowchart illustrating a method for displaying capsule endoscope images according to the first embodiment of the present invention;

FIG. 18 illustrates a procedure for displaying capsule endoscope images according to the first embodiment of the present invention; and

FIG. 19 is a flowchart illustrating a method for displaying capsule endoscope images according to the second embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

Hereinafter, an apparatus and method for displaying capsule endoscope images (wherein, the capsule endoscope images indicate images taken by a capsule endoscope) according to the present invention will be explained with reference to the accompanying drawings.

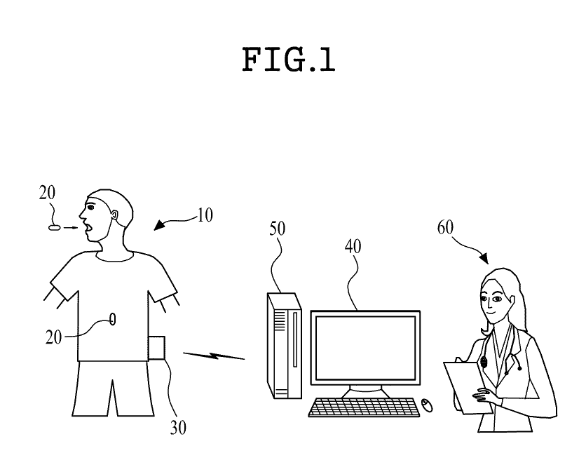

FIG. 1 illustrates a system for displaying capsule endoscope images according to the embodiment of the present invention.

As shown in FIG. 1, the system for displaying capsule endoscope images according to embodiment of the present invention includes a capsule endoscope 20, a receiving device 30, and a workstation 50.

By swallowing the ingestible capsule endoscope 20 through a mouth of a subject 10 to be examined (hereinafter, referred to as an ‘examinee’), the capsule endoscope 20 is inserted into the inside of the examinee 10. Then, image data is generated by using intra-subject images, that is, images of stomach, small intestine, large intestine and etc. photographed by the traversing capsule endoscope 20 until the capsule endoscope 20 is discharged out of the examinee 10. The generated image data is transmitted to the receiving device 30. At this time, the capsule endoscope 20 takes the images at regular intervals while traversing through the intestines of the examinee 10 by the peristalsis.

The capsule endoscope 20 may transmit the image data to the receiving device 30 by any one of a wireless communication method or a human body communication method, wherein the wireless communication method uses a narrow band radio frequency signal or ultra-wide band pulse signal, and the human body communication method uses a human body as a communication medium. In case of the capsule endoscope 20 using the wireless communication method, a high-frequency carrier with the image data is transmitted via a wireless antenna (not shown). In case of the capsule endoscope 20 using the human body communication method, the image data is converted into an electric signal, and the electric signal is supplied to at least two receiving electrodes (not shown) included in the capsule endoscope 20, whereby a current flows in the human body by an electric potential between the receiving electrodes. Preferably, the capsule endoscope 20 transmits the image data to the receiving device 30 by the human body communication method, but not necessarily.

The receiving device 30 can store the image data, which is transmitted from the capsule endoscope 20 by the wireless communication method or human body communication method, in a storing device (not shown); and also transmit the image data to the workstation 50. If using the wireless communication method, the receiving device 30 receives the image data transmitted from the capsule endoscope 20 via the wireless antenna (not shown).

If using the human body communication method, the receiving device 30 receives the image data transmitted from the capsule endoscope 20 according to the electric potential induced between at least two sensor-pads (not shown) attached to the examinee 10. For this, in case of the human body communication method, the receiving device 30 includes an analog processor (not shown) and a digital processor (not shown), wherein the analog processor (not shown) converts the image data into a digital signal by amplifying a signal transmitted from the sensor-pad and filtering out noises from the amplified signal, and the digital processor (not shown) modulates the digital signal through a signal processing.

The receiving device 30 may transmit the image data from the capsule endoscope 20 to the workstation 50 in real-time by the wireless communication method.

The aforementioned embodiment of the present invention discloses that the receiving device 30 transmits the image data to the workstation 50. In a modified embodiment of the present invention, the receiving device 30 may generate an endoscope image stream through the use of image data transmitted from the capsule endoscope 20; and may transmit the generated endoscope image stream to the workstation 50.

The workstation 50 generates the endoscope image stream by using the image data transmitted from the receiving device 30; extracts a representative image frame and/or neighboring image frame from the image frames included in the generated endoscope image stream; and displays the extracted representative image frame and/or neighboring image frame on a display device 40.

Instead of generating the endoscope image stream in the workstation 50, the receiving device 30 may directly generate the endoscope image stream, and then transmit the generated endoscope image stream to the workstation 50.

The workstation 50 according to the embodiment of the present invention forms a plurality of similar-image groups according to a similarity between each of the image frames for the generated endoscope image stream; extracts the representative image frame for each of the similar-image groups; and displays the extracted representative image frame on the display device 40. If a specific event occurs, the workstation 50 extracts the neighboring image frame from each similar-image group, whereby the extracted neighboring image frame may be displayed together with the representative image frame, or all the image frames included in each of the similar-image group may be displayed together with the representative image frame.

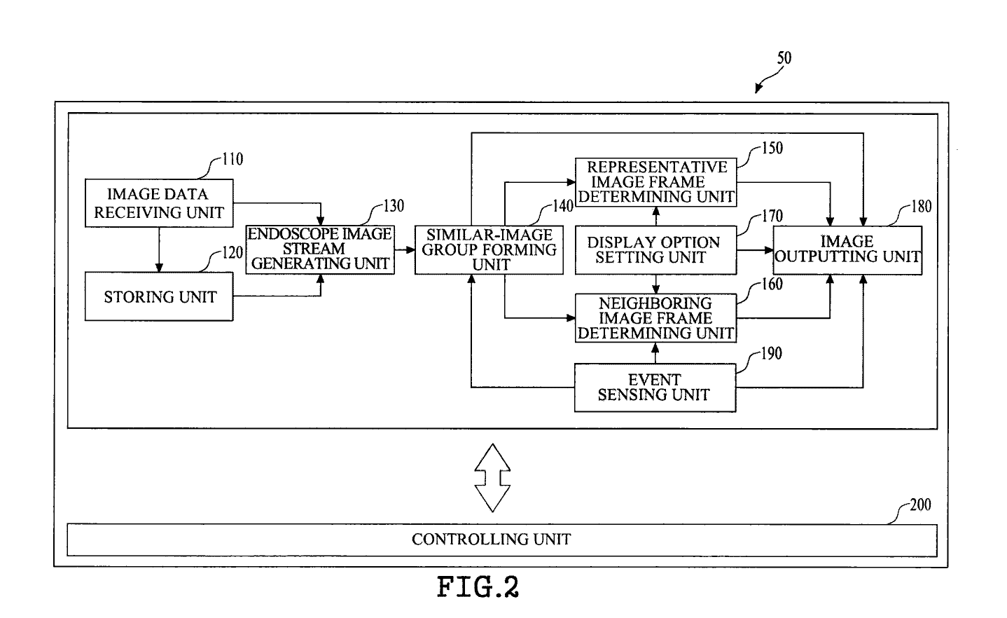

Hereinafter, the workstation 50 according to the embodiment of the present invention will be described with reference to FIG. 2.

FIG. 2 illustrates the workstation 50 according to one embodiment of the present invention.

As shown in FIG. 2, the workstation 50 according to one embodiment of the present invention includes an image data receiving unit 110, a storing unit 120, an endoscope image stream generating unit 130, a similar-image group forming unit 140, a representative image frame determining unit 150, a neighboring image frame determining unit 160, a display option setting unit 170, an image outputting unit 180, an event sensing unit 190, and a controlling unit 200.

The image data receiving unit 110 receives the image data transmitted from the receiving device 30, and stores the received image data in the storing unit 120.

The endoscope image stream generating unit 130 generates the endoscope image stream with ‘N’ endoscope image frames through the use of image data stored in the storing unit 120; and provides the generated endoscope image stream to the similar-image group forming unit 140.

The similar-image group forming unit 140 compares the respective image frames included in the endoscope image stream generated by the endoscope image stream generating unit 130 with one another, to thereby form the similar-image groups according to a predetermined reference-similarity value.

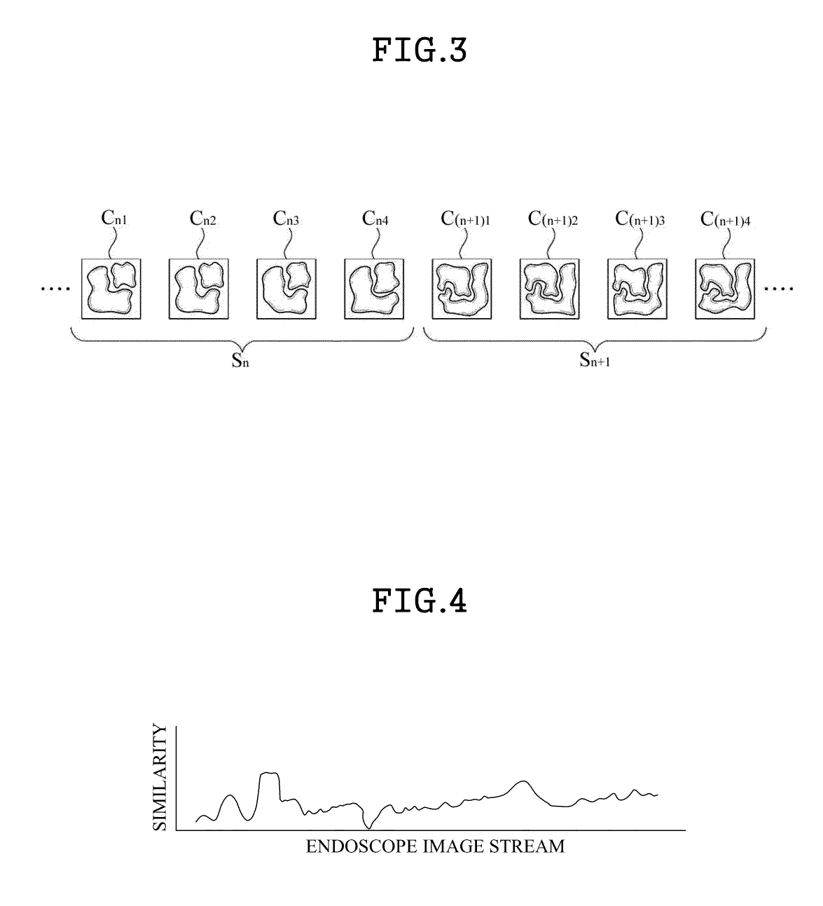

That is, as shown in FIG. 3, Cₙ₁ to Cₙ₄ image frames are regarded as the similar image frames taken in the same or neighboring area by the capsule endoscope 20. However, the similarity between Cₙ₁ to Cₙ₄ image frames and C₍ₙ₊₁₎₁ to C₍ₙ₊₁₎₄ image frames is lower, that is, C₍ₙ₊₁₎₁ to C₍ₙ₊₁₎₄ image frames are deemed to be different from Cₙ₁ to Cₙ₄ image frames according to the comparison result of similarity. Accordingly, the similar-image group forming unit 140 classifies Cₙ₁ to Cₙ₄ image frames into one group Sₙ; and classifies C₍ₙ₊₁₎₁ to C₍ₙ₊₁₎₄ image frames into another group Sₙ₊₁.

In one embodiment of the present invention, as shown in FIG. 4, the similar-image group forming unit 140 may form the similar-image groups according to the similarity between the temporally neighboring image frames, or according to the similarity between the predetermined image frame and the temporally-distant image frame.

When the similar-image groups are formed by the similar-image group forming unit 140, the predetermined reference-similarity value is configured based on a preset standard, and the respective image frames included in the endoscope image stream are compared with one another based on the predetermined reference-similarity value, to thereby form the plurality of similar-image groups. In one embodiment of the present invention, the similar-image group forming unit 140 may configure the reference-similarity value within a range of 0.0 to 1.0 based on whether it is focused on shortening of the time for displaying the endoscope image stream or improving preciseness in diagnosis by an observer's selection.

For example, if there are no hereditary diseases in the examinee's family history, and the examinee is young, the number of image frames to be included in one similar-image group is increased by configuring the low reference-similarity value, whereby it is possible to largely shorten the time consumed for displaying the capsule endoscope images. Meanwhile, if there are hereditary diseases in the examinee's family history, and the examinee is old, the number of image frames to be included in one similar-image group is decreased by configuring the high reference-similarity value, to thereby secure the diagnosis preciseness.

Based on the reference-similarity value previously configured according to the aforementioned standard, the similar-image group forming unit 140 compares the similarity between each of the image frames included in the endoscope image stream, to thereby form the similar-image groups.

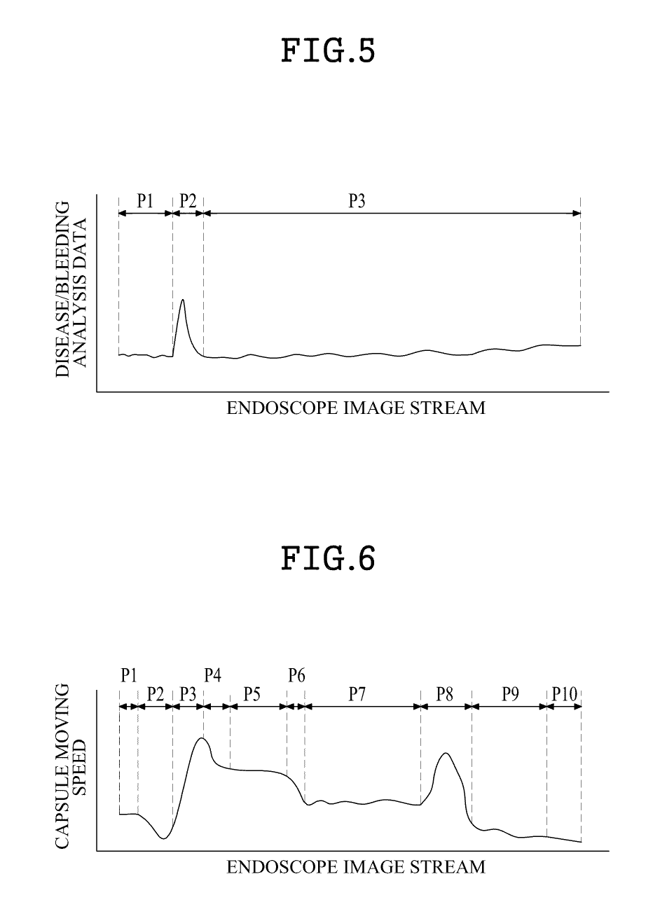

The aforementioned embodiment of the present invention discloses that the similar-image group forming unit 140 forms the similar-image groups according to the similarity between each of the image frames. In a modified embodiment of the present invention, the similar-image group forming unit 140 may analyze data of the respective image frame included in the endoscope image stream; detect a disease or bleeding pattern, as shown in FIG. 5; and form the plurality of similar-image groups (P1, P2, P3) by using disease and bleeding analysis data based on the detected result. At this time, the number of endoscope image streams included in each of the similar-image groups (P1, P2, P3) may vary according to the disease and bleeding analysis data.

For example, the similar-image group forming unit 140 generates the disease analysis data according to the reference-similarity value by comparing preset red(R), green(G) and blue(B) disease block data values with average red(R), green(G) and blue(B) data values of each image frame; and forms the similar-image groups through the use of generated disease analysis data. At this time, the disease block data are set in such a way that they correspond to the substantial disease images such as cancer, polyp, ulcer, erosion, and etc.

In another embodiment of the present invention, the similar-image group forming unit 140 may calculate an average red(R) data value of the image frame by using red(R) data values of respective pixels of the image frame data; and generate bleeding analysis data according to the calculated red(R) average data value. At this time, the bleeding analysis data may be a predetermined value between 0 and 1, or between 0 and 100.

Furthermore, if information for a location of the capsule endoscope 20 is included in the endoscope image stream, or if data for a location of the capsule endoscope 20 is calculated by using a moving speed of the capsule endoscope 20, as shown in FIG. 6, the similar-image group forming unit 140 may form the plurality of similar-image groups by using the location data of the capsule endoscope 20. In this case, the number ‘n’ of the endoscope image streams included in each of the similar-image groups (P1 to P10) may be varied.

Referring once again to FIG. 2, the representative image frame determining unit 150 determines the representative image frame of each similar-image group by using at least one image frame among the image frames included in each similar-image group.

In the first embodiment of the present invention, the representative image frame determining unit 150 may select any one image frame from the image frames included in each similar-image group; and may determine the selected image frame as the representative image frame.

In more detail, the representative image frame determining unit 150 may select at random any one image frame from the image frames included in each similar-image group according to an image-displaying option of display option. Since the similarity between each of the image frames included in one similar-image group is to be high (for example, within an error range of 5% or less), it is possible to select any one image frame at random among the image frames included in one similar-image group.

Also, the representative image frame determining unit 150 may determine the representative image frame to be any one image frame among the image frames included in each similar-image group by using any one of location of the image frame in each similar-image group; dynamic range of the image frame; brightness of the image frame; and complexity of the image frame.

If the representative image frame determining unit 150 determines the representative image frame by using the location of the image frame in each similar-image group, the representative image frame determining unit 150 calculates a length of each similar-image group by detecting the number of image frames included in each similar-image group; detects the location of each image frame within each similar-image group; and determines the representative image frame to be the image frame which is temporally or spatially positioned at the center of each similar-image group. Also, the representative image frame determining unit 150 may select the first or last image frame from the image frames included in each similar-image group; and determine the selected image frame as the representative image frame.

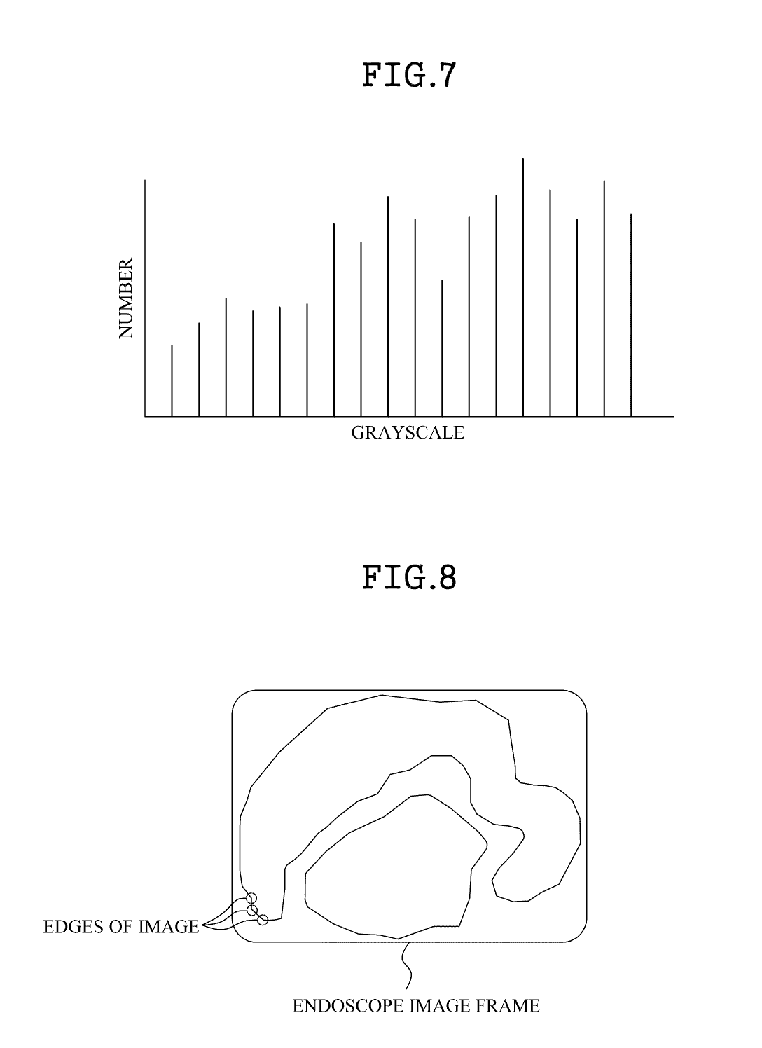

If the representative image frame determining unit 150 determines the representative image frame by using the dynamic range of the image frame, the representative image frame determining unit 150 detects a grayscale value of each of all pixels included in each image frame; detects a histogram of each image frame by measuring the number of the detected pixel grayscale values; detects the dynamic range of the image frame by using the detected histogram; and determines the image frame having the highest dynamic range in each similar-image group as the representative image frame for each similar-image group, as shown in FIG. 7. At this time, the representative image frame determining unit 150 may consider the grayscale values within a predetermined range (for example, 8, 16, 32, and etc.) as one group.

If the representative image frame determining unit 150 determines the representative image frame by using the brightness of the image frame, the representative image frame determining unit 150 detects the brightness of the image frame by calculating an average grayscale value of each of the image frames included in each similar-image group; and determines the image frame having the highest brightness as the representative image frame.

If the representative image frame determining unit 150 determines the representative image frame by using the complexity of the image frame, the representative image frame determining unit 150 detects image edges of each image frame; detects the complexity based on the number of the image edges; and determines the image frame having the highest complexity as the representative image frame, as shown in FIG. 8.

The aforementioned first embodiment of the present invention discloses that the representative image frame determining unit 150 determines the representative image frame of each similar-image group by using any one of the location of each image frame in the similar-image group; the dynamic range of the image frame; the brightness of the image frame; and the complexity of the image frame according to the image-displaying option of the display option.

In the second embodiment of the present invention, the representative image frame determining unit 150 may determine the representative image frame of each similar-image group by using at least two of the location of each image frame in the similar-image group; the dynamic range of the image frame; the brightness of the image frame; and the complexity of the image frame according to the image-displaying option of the display option.

That is, the representative image frame determining unit 150 applies a predetermined weight which is set by a user to each of data for the location of each image frame in the similar-image group, data for the dynamic range of the image frame, data for the brightness of the image frame, and data for the complexity of the image frame; calculates a result value of the image frame by combining at least two of the aforementioned data applied with the predetermined weight; and determines the image frame having the highest result value as the representative image frame.

In the third embodiment of the present invention, the representative image frame determining unit 150 may newly generate the representative image frame by using one or more image frames among the image frames included in each similar-image group.

First, the representative image frame determining unit 150 calculates an average value of the image frames included in one similar-image group; and generates the representative image frame based on the calculated average value. The image displayed on the display device 40 may be obtained by combining the brightness and saturation of pixels corresponding to the respective coordinates in a screen of the display device 40. Thus, according as the image frames can be generated by calculating an average value of brightness and saturation of the pixels corresponding to the same coordinates in the plurality of image frames, and arranging the calculated average value in the two-dimensional coordinates, the representative image frame can be generated therefrom.

Variation of the brightness or saturation displayed in the specific pixel of the image frames indicates that the respective image frames corresponding to the combination of the pixels are varied. Thus, the representative image frame, which corresponds to the typical image frame in the respective image frames, can be generated with the average image frame obtained by calculating the average value of brightness or saturation in the respective pixels.

For example, in case of the display unit having 1024*768 pixels, the average value of brightness or saturation at coordinates (5, 5) in the four image frames corresponds to the pixel value at coordinates (5, 5) in the representative image frame. If sequentially calculating the average value at coordinates from (0, 0) to (n, n), the average value of the pixel of all coordinates can be calculated so that it is possible to obtain the pixel value at all coordinates in the representative image frame.

In the aforementioned method, the representative image frame can be typified in the image frames included in one similar-image group. Thus, according as an observer makes a check on the average value of image frames, it is possible to reduce the playing time of image frames and to secure the preciseness in diagnosis.

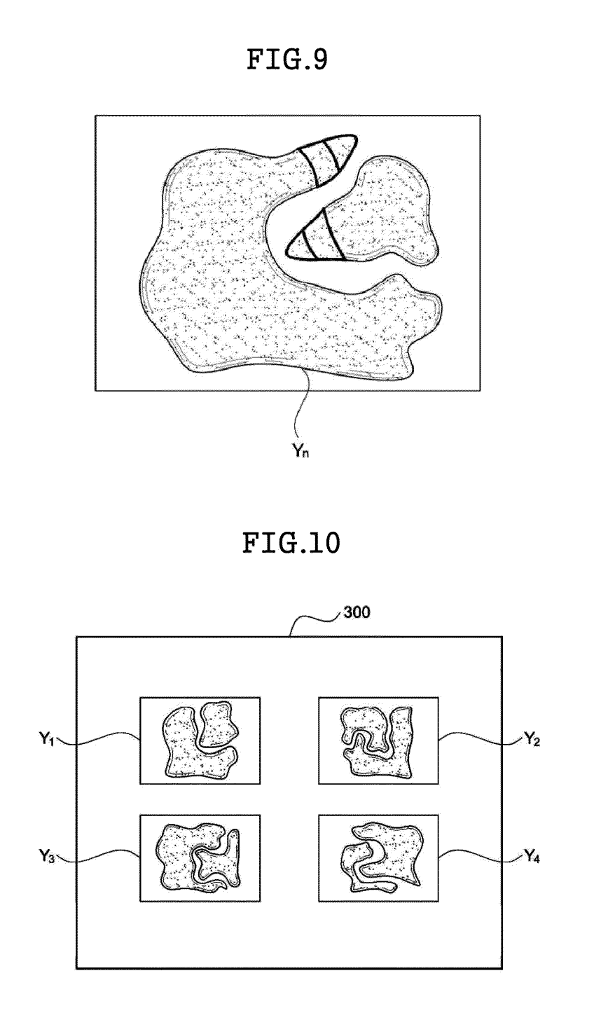

Then, the representative image frame determining unit 150 may generate the image frame under such circumstances that the plurality of image frames included in one similar-image group are overlapped and emphasized at their edges being not perfectly overlapped; and determines the generated image frame as the representative image frame. For example, as shown in FIG. 9, if the edges are not identical in the overlapped three image frames (Cₙ₁, Cₙ₂, Cₙ₃), the edge portions which are not identical are displayed relatively darker to be emphasized. This enables the observer to notice the difference between each of the image frames in one glance.

In this case, the perfectly-overlapped portions of the image frames are blurred so as to noticeably emphasize the edge portions which are not perfectly overlapped. Thus, the representative image frame substantially implies information about all image frames, to thereby secure the preciseness in diagnosis. Simultaneously, the time consumed for diagnosis can be reduced by enabling the observer to notice the difference between each of the image frames in one glance.

The representative image frame determining unit 150 may generate the representative image frame by applying a weight to one specific image frame among the plurality of image frames included in one similar-image group. In other words, when the image frames included in one similar-image group vary in variance of similarity, the image frame with the highest variance is regarded as the most-particular image frame with the lowest similarity, whereby the image frame with the highest variance may be selected as the representative image frame. Also, the representative image frame may be determined in such a way that the image frame with the highest variance of similarity is emphasized when displaying the overlapped image frames.

The most-particular image frame in one similar-image group has to be carefully observed since the image frame with the rapidly-changed similarity has high probability of disease. Thus, it is possible to largely reduce the time consumed for playing the image frame, and to raise the probability of detecting the disease.

Referring once again to FIG. 2, when it is determined that the neighboring image frame is displayed together with the representative image frame, the neighboring image frame determining unit 160 may determine the plurality of neighboring image frames among the image frames included in each similar-image group except the representative image frame by using any one of location of each image frame in the similar-image group, dynamic range of the image frame, brightness of the image frame, and complexity of the image frame according to the predetermined number of neighboring image frames.

In one embodiment of the present invention, when the occurrence of the specific event to be described is sensed by the event sensing unit 190, the neighboring image frame determining unit 160 may determine the neighboring image frames.

If determining the plurality of neighboring image frames by using the location of each image frame in each similar-image group, the neighboring image frames are determined to be the first and last image frames among the image frames included in each similar-image group by the neighboring image frame determining unit 160.

If determining the plurality of neighboring image frames by using the dynamic range of each image frame, the neighboring image frames are determined to be the plurality of image frames which are next to the representative image frame in rank of the dynamic range in each similar-image group by the neighboring image frame determining unit 160.

If determining the plurality of neighboring image frames by using the brightness of each image frame, the neighboring image frames are determined to be the plurality of image frames which are next to the representative image frame in rank of the brightness in each similar-image group by the neighboring image frame determining unit 160.

If determining the plurality of neighboring image frames by using the complexity of each image frame, the neighboring image frames are determined to be the plurality of image frames which are next to the representative image frame in rank of the complexity in each similar-image group by the neighboring image frame determining unit 160.

In another embodiment of the present invention, the neighboring image frame determining unit 160 applies a predetermined weight to each of data for the location of each image frame in the similar-image group, data for the dynamic range of the image frame, data for the brightness of the image frame, and data for the complexity of the image frame; calculates a result value of the image frame by combining at least two of the aforementioned data applied with the predetermined weight; and determines the neighboring image frames by using the plurality of image frames which are next to the representative image frame (MI) in rank of the result value.

In another embodiment of the present invention, the neighboring image frame determining unit 160 may determine the neighboring image frames by combining at least two of the aforementioned conditions.

The neighboring image frame determining unit 160 may determine the number of the neighboring image frames by using at least one of the user, the playing time of the image frames included in each similar-image group, the number of the representative image frames displayed on the diagnosis screen, and the number of the image frames included in the similar-image group according to the display option. Preferably, the neighboring image frame determining unit 160 may determine the number of the neighboring image frames according to the number of the image frames included in each similar-image group.

In one embodiment of the present invention, the neighboring image frame determining unit 160 may determine the number of the neighboring image frames by ‘N’ frame unit ('N′ is an integer), ‘N’ square root frame unit, or ‘N’ log scale frame unit in comparison to the number of the image frames included in each similar-image group according to the display option.

For example, if determining the number of the neighboring image frames by the ‘N’ frame unit, the neighboring image frame determining unit 160 may determine the number of the neighboring image frames by selecting 1 frame every 3 frames, 1 frame every 5 frames, or 1 frame every 10 frames.

In another example, if determining the number of the neighboring image frames by the ‘N’ square root frame unit, the neighboring image frame determining unit 160 may determine the number of the neighboring image frames by selecting 1 frame every 2 frames, 1 frame every 4 frames, or 1 frame every 9 frames.

In another example, if determining the number of the neighboring image frames by the ‘N’ log scale frame unit, the neighboring image frame determining unit 160 may determine the number of the neighboring image frames by selecting 1 frame every 10 frames, 2 frames every 100 frames, or 3 frames every 1000 frames.

Based on the aforementioned explanation, a method for determining the plurality of neighboring image frames in the neighboring image frame determining unit 160 will be explained as follows. When the neighboring image frames are determined by combining all the aforementioned conditions on assumption that the predetermined number of the neighboring image frames is 10, the neighboring image frame determining unit 160 firstly selects 2 frames of the next-highest ranked complexity after the representative image frame among the image frames included in the similar-image group.

Then, the neighboring image frame determining unit 160 selects 2 frames of the high brightness except the representative image frame and the afore-selected 2 frames; and then selects 2 frames of the high dynamic range except the representative image frame and the afore-selected 4 frames.

After that, the neighboring image frame determining unit 160 selects the first and last image frames except the representative image frame and the afore-selected 6 frames. Then, except the representative image frame and the afore-selected 8 frames, the neighboring image frame determining unit 160 selects 2 frames with the highest result value among the image frames obtained by applying the aforementioned weight thereto. Thus, 10 frames are finally determined to be the neighboring image frames.

The observer (See FIG. 1) sets the display option, and stores the display option in the display option setting unit 170. For example, the display option may comprise image-displaying options related with the number of the representative image frames displayed on the diagnosis screen; the number of the neighboring image frames displayed adjacent to the representative image frame; the method for determining the representative image frame or the neighboring image frame; and the method for arranging the image frames.

Then, the image outputting unit 180 displays the representative image frame determined by the representative image frame determining unit 150 on an image-displaying area of the display device 40. The method for displaying the representative image frame can be determined according to the selection of the observer on the aforementioned display option.

In one embodiment of the present invention, the image outputting unit 180 may display only one representative image frame. According to the observer's selection, the plurality of representative image frames (Y₁ to Y₄) may be displayed on one screen, as shown in FIG. 10. At this time, the plurality of representative image frames may be arranged on one screen in various ways, for example, a check pattern of square, a circular pattern, or an in-line pattern.

In order to reduce the examination time using the capsule endoscope, it is necessary to make efforts for reducing the displaying time of the representative image frame as well as to the displaying time of the respective image frames. As part of the efforts to reduce the examination time using the capsule endoscope, the plurality of representative image frames may be displayed on one screen, wherein the plurality of representative images might to secure the predetermined similarity owing to the temporal or spatial adjacency, even though the plurality of representative images are not included in the same similar-image group, thereby resulting in reduction of the displaying time by implementing a multi-view with the plurality of representative image frames.

The observer can selectively change the arrangement mode so as to precisely observe some areas suspected to have the disease, whereby one representative image frame having the some areas suspected to have the disease can be precisely observed by the observer. Furthermore, the neighboring image frame or all image frames included in the similar-image group corresponding to one representative image frame can be precisely observed so as to secure the preciseness in diagnosis.

Preferably, the multi-view arrangement may comprise data for the representative image frames with the temporal or spatial adjacency, that is, the representative image frames taken in the neighboring areas or close time points (for example, taken for a second).

In another embodiment of the present invention, the image outputting unit 180 may display the representative image frame together with the plurality of neighboring image frames on the image-displaying area 300. At this time, the size of the representative image frames and neighboring image frames displayed on the image-displaying area 300 can be changeable based on the number of representative image frames and neighboring image frames.

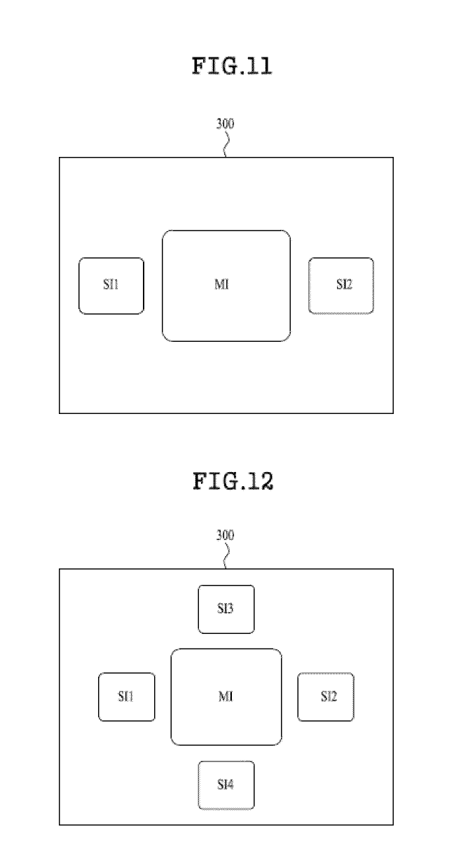

For example, as shown in FIG. 11, one representative image frame (MI) for each similar-image group and two neighboring image frames (SI1, SI2) for one representative image frame (MI) may be displayed on the image-displaying area 300 according to the display option. At this time, the two neighboring image frames (SI1, SI2) may be respectively displayed adjacent to the left and right sides of the representative image frame (MI).

In another example, as shown in FIG. 12, one representative image frame (MI) for each similar-image group and four neighboring image frames (SI1, SI2, SI3, SI4) for one representative image frame (MI) may be displayed on the image-displaying area 300 according to the display option. At this time, the four neighboring image frames (SI1, SI2, SI3, SI4) may be respectively displayed adjacent to the lower, upper, left and right sides of the representative image frame (MI).

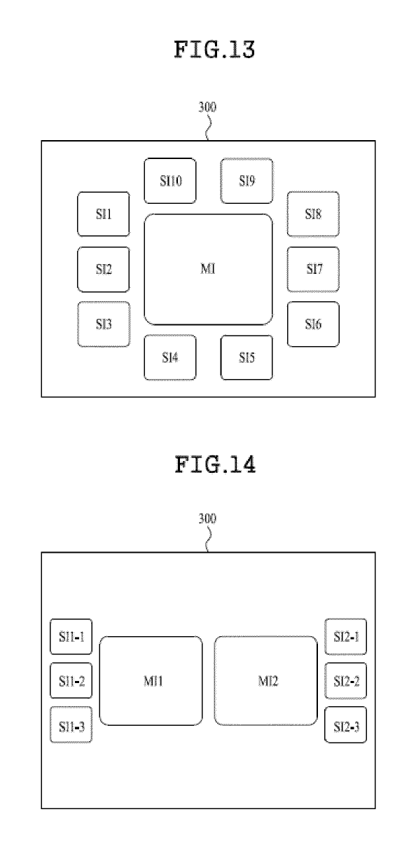

In another example, as shown in FIG. 13, one representative image frame (MI) for each similar-image group and ten neighboring image frames (SI1 to SI10) for one representative image frame (MI) may be displayed on the image-displaying area 300 according to the display option. At this time, the ten neighboring image frames (SI1 to SI10) may be respectively displayed adjacent to the lower, upper, left and right sides of the representative image frame (MI).

In another example, as shown in FIG. 14, two representative image frames (MI1, MI2) and three neighboring image frames (SI1-1, SI1-2, SI1-3, SI2-1, SI2-2, SI2-3) for each of the representative image frames (MI1, MI2) may be displayed on the image-displaying area 300 according to the display option. At this time, the three neighboring image frame (SI1-1, SI1-2, SI1-3) for the first representative image frame (MI1) may be displayed adjacent to the left side of the first representative image frame (MI1); and the neighboring image frames (SI2-1, SI2-2, SI2-3) for the second representative image frame (MI2) may be displayed adjacent to the right side of the second representative image frame (MI2).

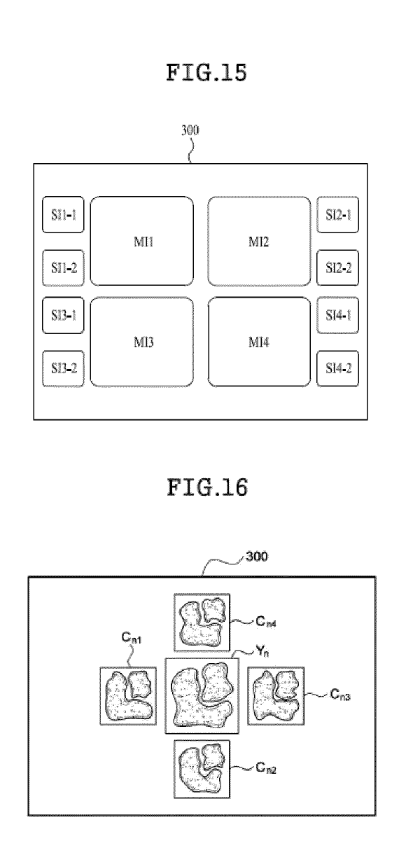

In another example, as shown in FIG. 15, four representative image frames (MI1 to MI4) and two neighboring image frames (SI1-1, SI1-2, SI2-1, SI2-2, SI3-1, SI3-2, SI4-1, SI4-2) for each of the representative image frames (MI1 to MI4) may be displayed on the image-displaying area 300 according to the display option. At this time, the two neighboring image frames (SI1-1, SI1-2) for the first representative image frame (MI1) may be displayed adjacent to the left side of the first representative image frame (MI1); the two neighboring image frames (SI2-1, SI2-2) for the second representative image frame (MI2) may be displayed adjacent to the right side of the second representative image frame (MI2); the two neighboring image frames (S13-1, SI3-2) for the third representative image frame (MI3) may be displayed adjacent to the left side of the third representative image frame (MI3); and the two neighboring image frames (SI4-1, SI4-2) for the fourth representative image frame (MI4) may be displayed adjacent to the right side of the fourth representative image frame (MI4).

If the event sensing unit 190 to be described senses the occurrence of the specific event, the image outputting unit 180 displays the representative image frame and the neighboring image frames.

In another embodiment of the present invention, when the event sensing unit 190 to be described senses the occurrence of the specific event during displaying the specific representative image frame, the image outputting unit 180 can display the corresponding representative image frame together with all image frames included in the similar-image group with the corresponding representative image frame on the image-displaying area 300.

For example, as shown in FIG. 16, if the occurrence of the specific event is sensed during playing the representative image frame (Yₙ) on the image-displaying area 300, the image frames (Cₙ₁ to Cₙ₄) included in the similar-image group of the corresponding representative image frame (Yₙ) are displayed in the circumference of the displayed representative image frame (Yₙ).

The representative image frame and the individual image frames may be arranged by using the aforementioned methods of FIGS. 11 to 13 to arrange the representative image frame and the neighboring image frames. In this case, the individual image frames are arranged on the area for the neighboring image frames in FIGS. 11 to 13. In addition, the representative image frame and the individual image frames may be arranged in various ways, for example, a check pattern of square, a circular pattern, or an in-line pattern.

The plurality of representative image frame and the individual image frames may be arranged by using the aforementioned methods of FIGS. 14 and 15 to arrange the representative image frame and the neighboring image frames. In this case, the individual image frames are arranged on the area for the neighboring image frames in FIGS. 14 to 15.

The arrangement mode of the representative image frame and the individual image frames can be determined according to the observer's selection.

Referring once again to FIG. 2, the event sensing unit 190 senses whether or not the specific event occurs by the observer during displaying the representative image frame on the image-displaying area. If the occurrence of the specific event is sensed, it is provided to the image outputting unit 180. Thus, the image outputting unit 180 outputs the corresponding representative image frame and the individual image frames included in the similar-image group with the corresponding representative image frame.

In one embodiment of the present invention, the specific event indicates that the observer selects a playing-stop button or temporarily playing-stop button, or clicks or double-clicks on the currently-displayed representative image frame when the currently-displayed representative image frame has unusualness or some areas suspected to have the disease.

In more detail, if the observer detects the unusualness or some areas suspected to have the disease in the currently-displayed representative image frame while observing only the representative image frame for reduction of the displaying time, the event occurs by stopping or temporarily stopping the display of the capsule endoscope image. Then, the event sensing unit 190 senses the event occurrence, and notifies the image outputting unit 180 of the event occurrence. Thus, the image outputting unit 180 displays the corresponding representative image frame together with the individual image frames included in the similar-image group with the corresponding representative image frame, whereby the observer can precisely observe all the individual image frames corresponding to the representative image frame suspected to have the disease.

Accordingly, it is possible to reduce the displaying time and also to secure the preciseness in diagnosis by precisely observing the corresponding image frame suspected to have the disease.

If the event occurs by the observer's click on the representative image frame or by an input of additional information, the event sensing unit 190 senses the event occurrence, and notifies the image outputting unit 180 of the event occurrence. Thus, the image outputting unit 180 displays the corresponding representative image frame together with the individual image frames included in the similar-image group with the corresponding representative image frame.

Also, when the event sensing unit 190 senses the event occurrence, the event sensing unit 190 notifies the neighboring image frame determining unit 160 of the event occurrence, whereby the neighboring image frame determining unit 160 can determine the neighboring image frames.

Referring once again to FIG. 2, the controlling unit 200 controls operations of the respective units included in the aforementioned workstation 50.

In addition to the aforementioned image-displaying area, a play menu (not shown) and a time bar display area (not shown) are displayed on the screen of the display device 40, wherein the play menu is provided to select a function for playing the capsule endoscope image; and the time bar display area is provided to display a recording time point of the capsule endoscope image and information for a proportional distance inside the intestines.

The play menu (not shown) may include menu icons for adjusting the frame rate of the capsule endoscope image displayed on the image-displaying area 300; for forward playing of the image; for reverse playing of the image; for fast forward playing of the image; for fast reverse playing of the image; for stopping of the image playing; and for temporarily stopping of the image playing by the observer's input. At this time, if the observer selects the menu icon for stopping of the image playing or for temporarily stopping of the image playing, it is possible to display all the individual image frames included in the similar-image group of the corresponding representative image frame being played on the image-displaying area 300 when selecting the menu icon for stopping of the image playing or for temporarily stopping of the image playing.

The time bar display area (not shown) is provided to display the recording time point of the capsule endoscope image and the information for the proportional distance inside the intestines. The time bar display area (not shown) includes a time bar which displays the recording time point and a location corresponding to the distance information for the image displayed on the image-displaying area 300. The observer can freely adjust the time bar so that the image corresponding to the location of the time bar is displayed on the image-displaying area 300.

A method for displaying the capsule endoscope image according to the present invention will be explained as follows.

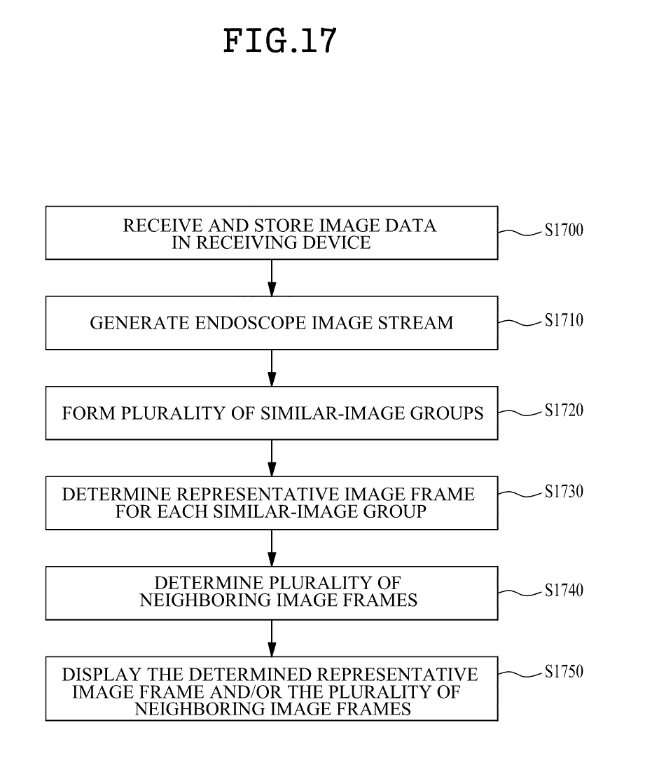

FIG. 17 is a flowchart illustrating a method for displaying the capsule endoscope image according to the first embodiment of the present invention.

First, the image data generated by the capsule endoscope inserted into the examinee is received and stored in the receiving device in step S1700.

Then, the endoscope image stream with the ‘N’ endoscope image frames is generated by using the received image data in step S1710.

Next, the plurality of similar-image groups are formed from the endoscope image stream in step S1720, wherein each similar-image group includes the plurality of image frames. In one embodiment of the present invention, the similar-image groups may be formed by using at least one of similarity between each of the image frames of the endoscope image stream, location data of the capsule endoscope, disease analysis data, and bleeding analysis data.

Based on the display option selected by the observer, the representative image frame for each similar-image group is determined in step S1730. In one embodiment of the present invention, the representative image frame may be determined by selecting any one from the image frames included in each similar-image group; or may be newly generated by using one or more image frames included in each similar-image group. The method for determining the representative image frame has been explained when describing the aforementioned representative image frame determining unit, whereby a detailed explanation about the method for determining the representative image frame will be omitted.

Based on the display option, the plurality of neighboring image frames for each similar-image group are determined in step S1740. The method for determining the plurality of neighboring image frames has been explained when describing the aforementioned neighboring image frame determining unit, whereby a detailed explanation about the method for determining the neighboring image frames will be omitted.

Then, the determined representative image frame and/or neighboring image frames are displayed in step S1750. According to the observer's selection, only one representative image frame may be displayed; or the plurality of representative image frames may be displayed in various arrangement modes, for example, the check pattern of square, the circular pattern, or the in-line pattern. Also, if displaying the representative image frame together with the neighboring image frame, the representative image frame and the neighboring image frame may be displayed in any one of the arrangement modes shown in FIGS. 11 to 15.

The aforementioned embodiments of the present invention disclose that the neighboring image frames are determined at all times. In the modified embodiment of the present invention, the neighboring image frames are determined only when the specific event occurs, and the determined neighboring image frames are displayed together with the representative image frame.

At this time, the specific event indicates that the observer selects the playing-stop button or temporarily playing-stop button, or clicks or double-clicks on the currently-displayed representative image frame when the currently-displayed representative image frame has unusualness or some areas suspected to have the disease.

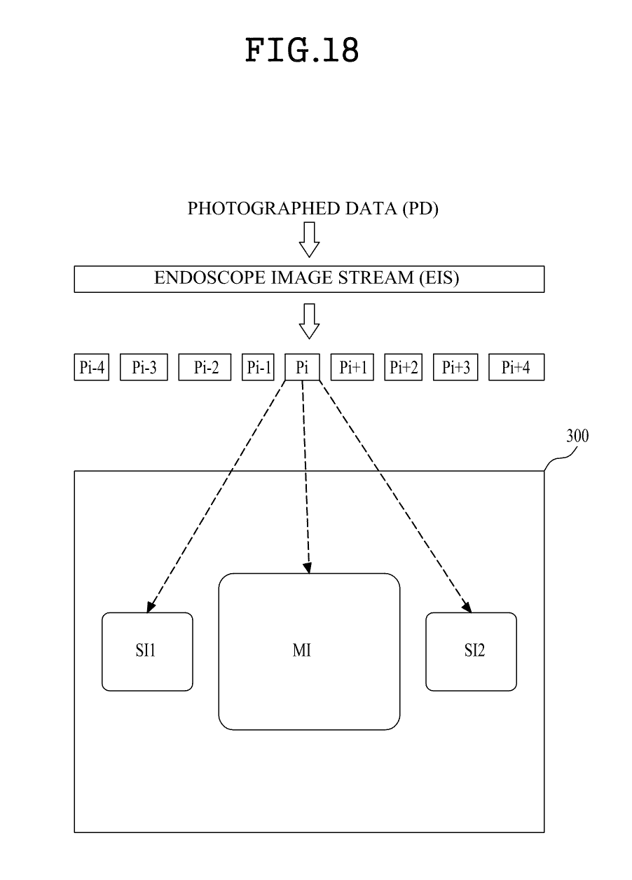

In the method for displaying the capsule endoscope image according to the first embodiment of the present invention, as shown in FIG. 18, the endoscope image stream is generated by using the image data provided from the receiving device 30; the plurality of similar-image groups (Pi) are formed by using the generated endoscope image stream; the diagnosis screen including the image-displaying area for displaying the representative image frame for each similar-image group (Pi) and the plurality of neighboring image frames are displayed on the display device 40, to thereby improve the efficiency in observer's diagnosis, and reduce the examination time by reducing the displaying time of the capsule endoscope image.

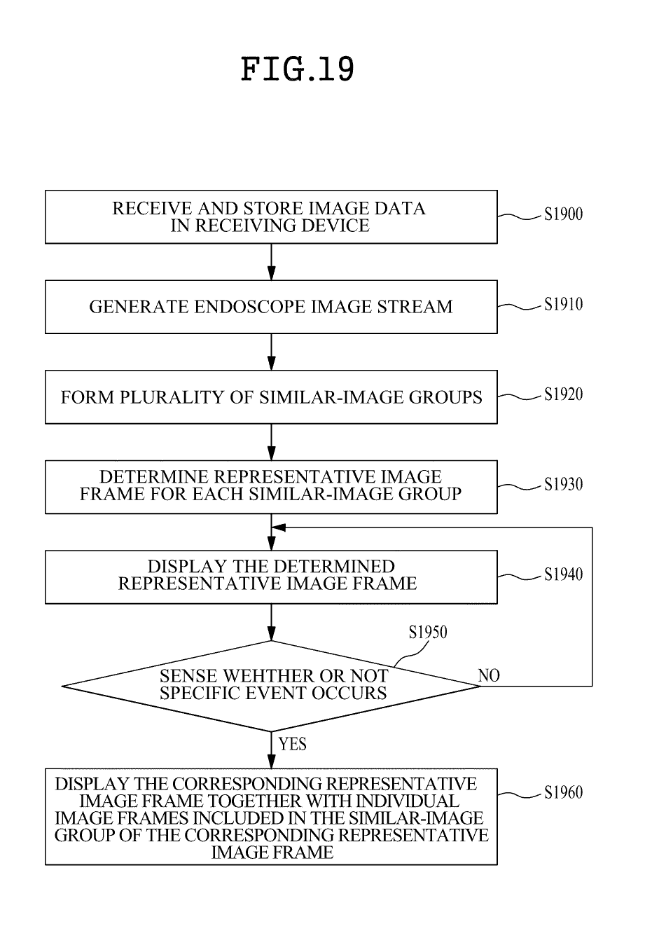

Hereinafter, a method for displaying the capsule endoscope image according to the second embodiment of the present invention will be explained with reference to FIG. 19.

First, the image data generated by the capsule endoscope inserted into the examinee is received and stored in the receiving device in step S1900.

Then, the endoscope image stream with the ‘N’ endoscope image frames is generated by using the received image data in step S1910.

Next, the plurality of similar-image groups are formed from the endoscope image stream in step S1920, wherein each similar-image group includes the plurality of image frames. In one embodiment of the present invention, the similar-image groups may be formed by using at least one of similarity between each of the image frames of the endoscope image stream, location data of the capsule endoscope, disease analysis data, and bleeding analysis data.

Based on the display option selected by the observer, the representative image frame for each similar-image group is determined in step S1930. In one embodiment of the present invention, the representative image frame may be determined by selecting any one from the image frames included in each similar-image group; or may be newly generated by using one or more image frames included in each similar-image group. The method of determining the representative image frame has been explained when describing the aforementioned representative image frame determining unit, whereby a detailed explanation about the method for determining the representative image frame will be omitted.

Then, the determined representative image frame is displayed in step S1940. According to the observer's selection, only one representative image frame may be displayed; or the plurality of representative image frames may be displayed in various arrangement modes, for example, the check pattern of square, the circular pattern, or the in-line pattern.

After that, it is determined whether or not the specific event occurs during playing the representative image frame in step S1950. When it is determined that the specific event occurs, the corresponding representative image frame is displayed together with the individual image frames included in the similar-image group of the corresponding representative image frame in step S1960.

In one embodiment of the present invention, the specific event indicates that the observer selects the playing-stop button or temporarily playing-stop button, or clicks or double-clicks on the currently-displayed representative image frame when the currently-displayed representative image frame has unusualness or some areas suspected to have the disease.

The individual image frames may be displayed in the arrangement mode to surround the representative image frame, as shown in FIGS. 11 to 15; or may be displayed in various arrangement modes, for example, the check pattern of square, the circular pattern, or the in-line pattern.

In the method for displaying the capsule endoscope image according to the present invention, the representative image frame which can be typified in the identical or similar image frames is firstly observed so as to reduce the playing time of the image frames; and then all the image frames included in the similar-image group with the representative image frame suspected to have the disease are secondly observed so as to secure the preciseness in diagnosis.

If it is determined that the specific event does not occur in step S1950, other representative image frames included in other similar-image groups are displayed in sequence.

The aforementioned method for displaying the capsule endoscope image according to the embodiments of the present invention can be embodied as a program type performed by various computers including CPU, RAM, and ROM, etc., wherein the program may be stored in a computer readable storage medium, for example, hard disk, CD-ROM, DVD, ROM, RAM, or flash memory.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

As mentioned above, the plurality of similar-image groups are formed by using the endoscope image stream, and the representative image frame for the at least one similar-image group and the plurality of neighboring image frames are displayed on the display device 40, to thereby improve the efficiency in observer's diagnosis, and reduce the examination time by reducing the displaying time of the capsule endoscope image.

When symptoms of the disease are detected in the corresponding representative image frame, the individual image frames included in the similar-image group of the corresponding representative image frame are displayed together with the corresponding representative image frame, so that it is possible to prevent the diagnosis preciseness from being lowered, wherein the diagnosis preciseness might be lowered by the reduced displaying time of the capsule endoscope image.

What is claimed is:

1. A method for displaying a capsule endoscope image comprising:
receiving image data taken by a capsule endoscope inserted into the inside of an examinee;
generating an endoscope image stream by using the received image data;
forming a plurality of similar-image groups with a plurality of image frames by using the endoscope image stream;
determining a representative image frame for each similar-image group by using the image frames included in each similar-image group; and
displaying the representative image frame for each similar-image group.

2. The method of claim 1, wherein the plurality of similar-image groups are formed by using at least one of a similarity between each of the image frames for the endoscope image stream, location data of the capsule endoscope, and disease and bleeding analysis data obtained by detecting at least one of disease and bleeding patterns from the image frames for the endoscope image stream.

3. The method of claim 1, wherein the step of determining the representative image frame comprises:
selecting any one image frame from the image frames included in each similar-image group; or
combining one or more image frames among the image frames included in each similar-image group.

4. The method of claim 3, wherein, if selecting any one image frame from the image frames included in each similar-image group, the representative image frame is determined to be the image frame which is temporally or spatially positioned at the center of each similar-image group; the image frame having the highest dynamic range based on a histogram of grayscale; the image frame having the highest brightness; or the image frame having the highest complexity based on the number of edges of the image frame.

5. The method of claim 3, wherein, if combining one or more image frames among the image frames included in each similar-image group, the representative image frame is generated by an average image of the image frames included in one similar-image group; the representative image frame is generated by overlapping the image frames included in one similar-image group and being emphasized at their edges being not perfectly overlapped; or the representative image frame is generated by combining one or more image frames applied with a weight among the image frames included in one similar-image group.

6. The method of claim 1, wherein the step of displaying the representative image frame comprises:
displaying the corresponding representative image frame together with other representative image frames which are temporally positioned adjacent to the corresponding representative image frame.

7. The method of claim 1, further comprising:
determining a plurality of neighboring image frames among the image frames included in each similar-image group,
wherein the corresponding representative image frame is displayed together with the plurality of neighboring image frames determined in the similar-image group of the corresponding representative image frame for the step of displaying the representative image frame.

8. The method of claim 7, wherein the plurality of neighboring image frames are determined by using at least one of the temporal or spatial first and last image frames among the image frames included in each similar-image group; the image frames of the next-highest ranked dynamic range based on the histogram of grayscale after the representative image frame; the image frames of the next-highest ranked brightness after the representative image frame; the image frames of the next-highest ranked complexity based on the number of edges of the image frame after the representative image frame.

9. The method of claim 7, wherein the number of neighboring image frames is determined by any one of a user, playing time of the image frames included in each similar-image group, the number of the representative image frames displayed on a diagnosis screen, and the number of the image frames included in the similar-image group.

10. The method of claim 1, further comprising:
determining whether or not a specific event occurs,
wherein, if the specific event occurs, the corresponding representative image frame is displayed together with the individual image frames included in the similar-image group of the corresponding representative image frame for the step of displaying the representative image frame.

11. The method of claim 10, wherein the specific event indicates that the user selects a playing-stop button or temporarily playing-stop button, or clicks or double-clicks on the representative image frame for the step of displaying the representative image frame.

12. A record media storing a program for carrying out the method of claim 1.

13. An apparatus for displaying a capsule endoscope image comprising:
an endoscope image stream generating unit for generating an endoscope image stream by using image data taken by a capsule endoscope inserted into the inside of an examinee;
a similar-image group forming unit for forming a plurality of similar-image groups with a plurality of image frames by using the endoscope image stream;
a representative image frame determining unit for determining a representative image frame for each similar-image group by using at least one image frame among the image frames included in each similar-image group; and
an image outputting unit for displaying the representative image frame determined by the representative image frame determining unit on a display device.

14. The apparatus of claim 13, wherein the similar-image group forming unit forms the plurality of similar-image groups by using at least one of a similarity between each of the image frames for the endoscope image stream, location data of the capsule endoscope, and disease and bleeding analysis data obtained by detecting at least one of disease and bleeding patterns from the image frames for the endoscope image stream.

15. The apparatus of claim 13, wherein the representative image frame determining unit determines the representative image frame by selecting any one image frame from the image frames included in each similar-image group, or combining one or more image frames among the image frames included in each similar-image group.

16. The apparatus of claim 15, wherein, if the representative image frame determining unit determines the representative image frame by selecting any one image frame from the image frames included in each similar-image group, the representative image frame determining unit selects the image frame which is temporally or spatially positioned at the center of each similar-image group; the image frame having the highest dynamic range based on a histogram of grayscale; the image frame having the highest brightness; or the image frame having the highest complexity based on the number of edges of the image frame.

17. The apparatus of claim 15, wherein, if the representative image frame determining unit determines the representative image frame by combining one or more image frames among the image frames included in each similar-image group, the representative image frame determining unit generates the representative image frame by an average image of the image frames included in one similar-image group; by overlapping the image frames included in one similar-image group and being emphasized at their edges being not perfectly overlapped; or by combining one or more image frames applied with a weight among the image frames included in one similar-image group.

18. The apparatus of claim 13, further comprising a neighboring image frame determining unit for determining a plurality of neighboring image frames among the image frames included in each similar-image group,
wherein the image outputting unit displays the corresponding representative image frame together with the plurality of neighboring image frames determined in the similar-image group of the corresponding representative image frame.

19. The apparatus of claim 18, wherein the neighboring image frame determining unit determines the plurality of neighboring image frames by using at least one of the temporal or spatial first and last image frames among the image frames included in each similar-image group; the image frames of the next-highest ranked dynamic range based on the histogram of grayscale after the representative image frame; the image frames of the next-highest ranked brightness after the representative image frame; the image frames of the next-highest ranked complexity based on the number of edges of the image frame after the representative image frame.

20. The apparatus of claim 13, further comprising an event sensing unit for determining whether or not a specific event occurs by a user's selection for a playing-stop button or temporarily playing-stop button, or click or double-click on the representative image frame for the step of displaying the representative image frame,
wherein, if the event sensing unit senses the occurrence of the specific event, the image outputting unit displays the corresponding representative image frame together with the individual image frames included in the similar-image group of the corresponding representative image frame.
